(19) United States
(12) Patent Application Publication
(10) Pub. No.: US 2023/0364827 A1
(43) Pub. Date: Nov. 16, 2023

(54) MOLD FOR PRECAST REINFORCED CONCRETE HEAVY DUTY RETAINING WALL

(71) Applicant: Phiproei THOOPPHONTHAP, Amphur Pakkred, Nonthaburi (TH)

(72) Inventor: Phiproei THOOPPHONTHAP, Amphur Pakkred, Nonthaburi (TH)

(21) Appl. No.: 17/909,379

(22) PCT Filed: Jun. 1, 2021
(86) PCT No.: PCT/TH2021/000028

§ 371 Date: Sep. 4, 2022

(30) Foreign Application Priority Data
Feb. 1, 2021 (TH) 2103000310

(51) Int. Cl. B28B 7/00; B28B 7/20; E02D 29/02

(52) U.S. Cl. CPC B28B 7/0079; B28B 7/0014; B28B 7/20; E02D 29/02; B28B 7/0041

(57) ABSTRACT

A heavy duty retaining wall mold. The concept of invention by requiring Precast Reinforced concrete laying characteristic, when removed work piece from mold, the from face is in a face up manner. The inventions associated with this concept are comprises of three group, first are Front Panel and Rear Panel, all sizes are equal in all respect, second are left panel and right panel, all sizes are equal in all respect, and the length of them are shorter than Front and Rear Panels. Third are central parts group, which divided in to two groups, first group are on the upper part could he assemble and disassemble, second group are on the lower part of none disassemble parts. The pouring system by poured fresh concrete from the upper square Front face the vacancy area.

### TECHNICAL FIELD

The present invention pertains generally to retaining walls. Specifically, the invention related to installation relates to mold for precast reinforced concrete heavy duty retaining wall for completely of mass products.

### BACKGROUND ART

Precast reinforced concrete heavy duty retaining wall WO/2018/160143 this innovation products modified from Precast reinforced concrete walls H shape WO/2015/199622. The objective of these innovation desired to evolution the traditional construction methods cast-in-place concrete walls change to Precast concrete wall.

Precast reinforced concrete wall H-Shape, the prior art Publication number WO120151199622 have two types of Blocks, a full block and a half block. The installation process is very bard and complicated, cause these products are very large size of block, very heavy, difficult to cast from complicated of mold and methods of wall installation, and methods of embedded horizontal rebars in both wall panels are not flexible and not suitable.

The molds of Precast reinforced concrete heavy duty retaining wall are steel structure, convenient to disassemble and assemble, it is stable and strong to withstand long term use. Easy to moved to the construction site, reduce the shipping and damages occurred.

Having thus generally described the nature of the invention, particular reference will be made to the accompanying drawing, shown by way of illustration preferred embodiments thereof and in which.

### BRIEF DESCRIPTION OF DRAWINGS

FIG. 1 is a perspective view of Precast reinforced concrete heavy duty retaining wall, laying characteristic which front face is in a face up manner.

FIG. 2 is a perspective view of mold for Precast reinforced concrete heavy duty retaining wall.

FIG. 3 is a plan view of mold for Precast reinforced concrete heavy duty retaining wall, shown disassembling.

FIG. 4 is a front sectional view of mold Precast reinforced concrete heavy duty retaining wall.

FIG. 5 is a front sectional view of mold for Precast reinforced concrete heavy duty retaining wall, shown disassemble parts and none disassemble parts.

FIG. 6 is a detailed of steel rod of mold for precast reinforced concrete heavy duty retaining wall.

FIG. 7 is a Central box, of Precast reinforced concrete heavy duty retaining wall.

### DISCLOSURE OF THE INVENTION

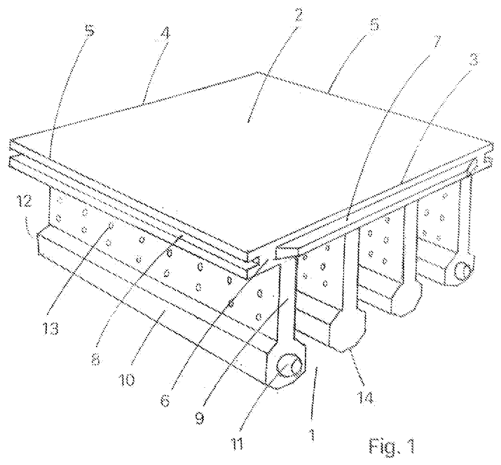

As shown in FIG. 1 is a Precast reinforced concrete heavy duty retaining wall. (L), having Front face panel (2) in a face-up manner. Front edge line (3) and Rear edge line (4), Left and Right edge line (5), all the length of four sides are equal, Parallel and square. Wall thickness (6) and the center of wall thickness of Front face (3) having Straight-ridge (7). And at the center line of wall thickness (6), of Rear edge line (4), and the left edge Line, the right edge line (5) having grooves (8) at three sides, the size of all grooves are the same center and equal in all respect. When take Straight-ridge attached to the rear groove, it would be fit together. The rear area of Front face (2) from Front edge line (3) to Rear edge line (4) having four fin (9), the distance of each fin are equally, parallel, and parallel to left and right edge line (5). Tips of each lower fin (9) having Regular octagon columns (10) and homogeneous to each fin, the top surface of right hand and left hand of outer left and outer right of Regular octagon columns having Protrude male Interlocking (11), on the contrary the rear surface of Regular octagon columns (10) having Female Interlocking (12) the center line corresponds to Protrude male Interlocking (11) attached to female Interlocking (12), it would be fit together. Each fin (9) having many round holes (13) each round hole from Left hand fin passed to right hand fin, any one hole are concentric line for inserted horizontal rebars. The lowest sides of Regular octagon columns (10.) having four Rear sides surface (14).

Laying characteristic of Precast reinforced concrete heavy duty retaining wall (1), Front face (2) is in a face -up manner, when removed from mold.

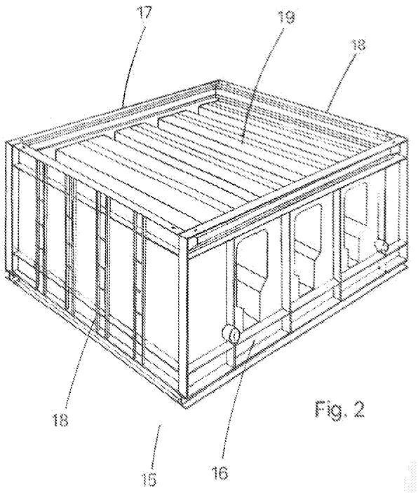

As shown in FIG. 2 is a perspective view of mold for Precast reinforced concrete heavy duty retaining wall (15) having Front Panel (16), Rear Panel (17) Left and Right Panel (18), and Central parts group (19). The material of mold mostly are steel. Method to disassemble, first removed Front Panel (16), and Rear Panel (17). Second removed both left and right panel (18), then removed Central parts group (19).

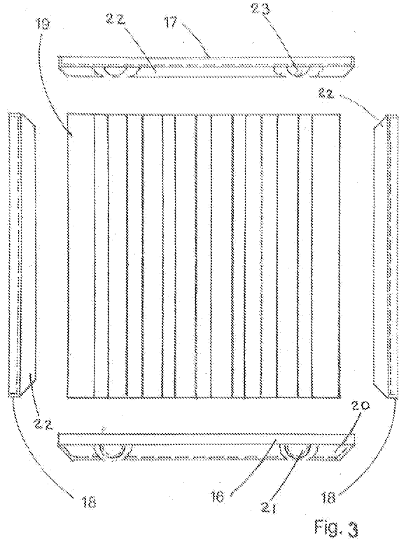

As shown in FIG. 3 is a plan view of Mold for Precast reinforced concrete heavy duty retaining wall mold (15) divided in to five parts as follows. First is Front Panel (16) which having Straight-ridge female mold (20), and a pair of Left and Right protrude female mold (21). Second is a Rear Panel (17) having Straight-ridge male mold (22) and a pair of protrude male mold (23), the size of both panels (16) and (17) are equal in all respect and longer than left and right Panels (18). Third and Forth are left panel and right panel (18) having Straight-ridge male molds (22), the size of left and right panel are equal in all respect. Fifth is Central parts group (19).

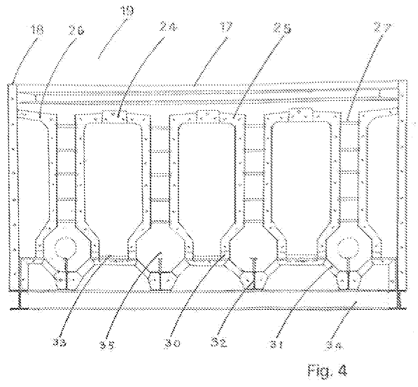

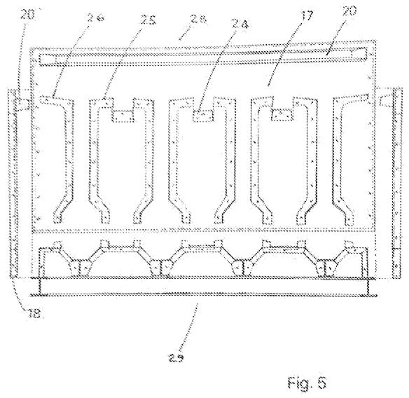

As shown in FIG. 4 and FIG. 5 are the details of Central parts group (12), of mold for Precast reinforced concrete heavy duty retaining wall, consisted of Central box (24) assemble at the middle between both Formwork Panels (25), the .length of central box (24) is equal and parallel to the Left and Right edge line (5), there are three boxes in one mold. The panels besides central box (24)are a pair of form work panels (25) the length of them are equal to the length of central box, the amount of formwork panels are six pieces, all of form work panels (25) are equal in all respect. The outer left and outer right panels are a pair of left and right form work panels (26) which both panels are equal in all respect, and the length of them are equal to the length of form work panels (25). There are many steel tubes (27) using for keep space of wall thickness of Fin (9) and for inserted horizontal rebars passed to each fin.

Each parts as mentioned above could be assemble before cast and disassemble parts (28) after cast.

The lower group is none disassemble parts (29) most upper parts of lower group are Support rail (30) which fastened to Equal leg angle frame (31) without removing and fastened to Form work panels (25), Left and right Panels which could be disassemble and assembled with bolts, the length of Support rail are equal to the length of Form work panels (25), there are eight Support rail in one mold. Equal leg angle frame (31) for Supported and laid along Support rail (30) the amount of them are not less than four pieces. The lower parts are H-beam (32) there are four H-beam in one mold, Using for supported along the Regular octagon columns attached to Rear side surface (14), the length of them are equal to the length of Support rail (30).The parts between Support rail (30) are Roller (33) using for mobility in sliding From work panels after cast, the amount of them are equal to the amount of equal leg angle frame (31). The lowest frame for Supported all upper loads are Support base (34). After assemble both Formwork Panels (25) included Equal leg angle frame (31) and H-beam (32), they would be takes Regular octagon shape (35).

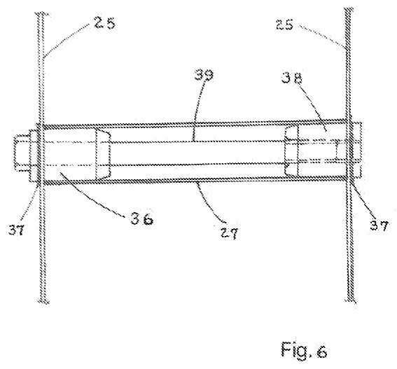

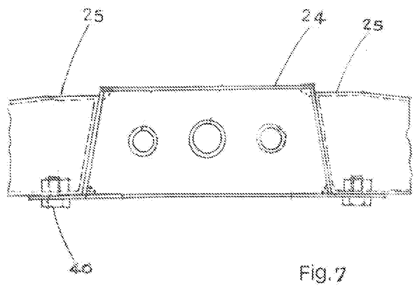

As shown in FIG. 6 and FIG. 7 is a steel tubes (27), inside round hole having Bolt insert rod (36) inserted in one side of hole attached inside surface of steel tube (27) and attached to the Fin (9) the external of Bolt insert rod locked to the Fin by the used of External snap ring (37) in the opposite having Internal thread rod (38) inserted in opposite direction of Bolt insert rod (36) and locked of said, then inserted Bolt (39) passed to Internal thread rod (38) and tighten.

Central box (24) the figuration as trapezoid assemble at central beside a Pair of Formwork Panels (25) and at the lower surface having holes attached nuts of Form work panels and fastened with bolts.

1. A Precast reinforced concrete heavy duty retaining wall, said when removed from the mold, laying characteristic which Front face is in a face up manner. Front edge line and Rear edge line, Left and Right edge line all the length of four sides are equally, parallel and square. The center line of wall thickness of Front edge line having Straight ridge, and at the center line of wall thickness of Rear edge line, the left edge line, the right edge line having groove, the size of all grooves are equal in all respect. The rear area of Front face panel having four fins, the distance of each fin are equal and parallel, and parallel to the left and right edge line. Tips of each lower fin having Regular octagon columns, top surface of right hand and left hand of outer left and outer right of Regular octagon columns having Protrude male Interlocking, and on the contrary the rear surface of Regular octagon columns having Female Interlocking. Each fin having many round holes, each hole are concentric line for inserted horizontal rebars. The lowest sides of Regular octagon columns having four rear sides surface.

2. Mold as claimed in claim 1 wherein Precast reinforced concrete heavy duty retaining wall mold is divided in to five parts. First part is Front Panel which having Straight ridge female mold and a pair of left and right protrude female mold. Second Part is a Rear Panel having Straight ridge male mold and a pair of protrude male mold, the size of both panels are equal in all respect and longer than left and right Panels. Third part and Forth part are left and right Panels having Straight ridge male molds, the size of left and right Panels are equal in all respect. Fifth part is Central parts group.

3. The Central parts group as claimed in claim 2 wherein mold for Precast reinforced concrete heavy duty retaining wall, consisted of Central box assemble at the middle between both Formwork Panels, the length of Central box is equal and parallel to the left and right edge line, there are three boxes in one mold. The panels beside Central box are a Pair of Formwork Panels, the length of them are equal to the length of Central box, the amount of Formwork Panels are six pieces, all of Form work panels are equal in all respect. The outer left and outer right Panels are a pair of Left and Right Form work panels, which both panels are equal in all respect, and the length of them are equal to the length of Form work panels. There are many steel tubes using for keep space of wall thickness of Fin and for inserted horizontal rebars passed to each fin.

4. The lower group as claimed in claim 3 wherein are none disassemble parts. Most upper parts of lower group are Support rail which fastened to Equal leg angle frame without removing and fastened to Formwork Panels, Left and Right Panels could be disassemble and assemble with bolts, the length of Support rail in one mold are equal to the length of Form work panels, there are eight Support rail in one mold. Equal leg angle frame for. Supported and laid along the Support rail, the amount of them are not less than four Pieces. The lower parts are H-beam having four H-beam in one mold, using for supported along the Regular octagon columns attached to the Rear side surface, the length of them are equal to the length of Support rail. The parts between Support rail are Roller using for mobility In sliding Form work panels after cast the amount of them are equal to the amount of Equal leg angle frame. The lowest frame for Supported all upper load are Support base. After assemble both Formwork Panels, included Equal leg angle frame and H-beam, they would be takes Regular octagon shape.

5. Steel tubes as claimed in claim 3 wherein inside the hole of tube having Bolt insert rod, inserted in one side of hole attached inside surface of tube and attached to the Fin, the external of Bolt insert rod locked to the Fin by the used of External snap ring, in the opposite having Internal thread rod, inserted in opposite Bolt insert rod and locked of said, then inserted Bolt passed to Bolt insert rod to Internal thread rod, and tighten.
